(19) United States
(12) Patent Application Publication
(10) Pub. No.: US 2015/0321230 A1
(43) Pub. Date: Nov. 12, 2015

(54) CONCRETE REMOVAL METHODS AND SYSTEMS

(71) Applicant: Global Polishing Systems LLC, Henderson, NV (US)

(72) Inventor: Mark Wetherell, Henderson, NV (US)

(21) Appl. No.: 14/704,787

(22) Filed: May 5, 2015

Related U.S. Application Data
(60) Provisional application No. 61/990,526, filed on May 8, 2014.

(51) Int. Cl. B08B 9/08; B28C 5/42

(52) U.S. Cl. CPC B08B 9/0817; B28C 5/4203

(57) ABSTRACT

A method for removing concrete from a concrete mixing drum is disclosed. The method may comprise applying a solution including amorphous colloidal silicate to an interior surface of the concrete mixing drum, allowing the solution to penetrate concrete adhered to the interior surface, dislodging one or more pieces of concrete from the interior surface, removing the one or more pieces of concrete from the mixing drum, and allowing the solution to form a coating on the interior surface to counteract further adhesion between concrete and the mixing drum.

### CROSS-REFERENCE TO RELATED APPLICATION

This application claims priority to U.S. Provisional Application No. 61/990,526, filed May 8, 2014, which is hereby incorporated by reference in its entirety.

### TECHNICAL FIELD

The subject invention generally concerns concrete removal from concrete mixers. More particularly, the present invention relates to use of an amorphous colloidal silica solution to remove concrete from concrete mixers.

### BACKGROUND OF THE INVENTION

Concrete is a composite material generally defined as a mixture of two components, namely, aggregates and paste. The paste, which typically includes cement (e.g., Portland cement) and water, binds the aggregates (sand and gravel or crushed stone) into a rock-like mass as the paste hardens. The paste hardens due to the chemical hydration reaction between the cement and water.

Concrete often gets stuck to the inside parts of the mixer and remains in the drum after discharging the load, thus causing concrete buildups. A concrete buildup inside the drum will impair the mixing and discharge performance of the mixer as well as lower its rated capacity. If buildups are not removed immediately after use of the mixer, the buildups may harden and continue to accumulate.

The hard concrete may also break off from inside the drum while a fresh load of concrete is inside the drum. Thus, the hard concrete would be mixed with the fresh load of concrete. This hardened material must be removed from the finished concrete, which typically requires the use of a saw.

Cleaning fresh and hardened concrete from inside the mixer drum is also required for reasons other than ensuring longer service life and better performance of the mixer. For example, Department of Transportation (DOT) certified batch plants must have trucks cleaned and maintained because of the hardened material that falls off into new concrete batches.

Some solutions to the problem include the application of corrosive or caustic chemicals, including acids, to the drum interior. However, such chemical applications are expensive and the chemicals themselves are corrosive and can cause damage to the interior of the drum as well as adversely affect future loads of concrete.

The concrete buildup is therefore often manually removed by a worker entering the drum and using a chipping hammer or similar device, which is a dangerous task, as well as being tedious, difficult and time-consuming.

Accordingly, there is a need for improvement in the removal of concrete from the drum to prevent buildup of hard concrete inside the mixer.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a block diagram of one embodiment of a method for removing concrete from a concrete mixing drum.

FIG. 2 illustrates a perspective view of an exemplary pumped delivery and spray apparatus with a partial concrete mixing drum.

FIG. 3 is a block diagram of an embodiment of a method for preventing buildup of concrete in a concrete mixing drum.

Corresponding reference characters indicate corresponding parts throughout the drawings.

### SUMMARY OF THE INVENTION

In one aspect of the present invention, a method for removing concrete from a concrete mixing drum is disclosed. A solution including amorphous colloidal silicate is applied to an interior surface of the concrete mixing drum. The solution penetrates concrete adhered to the interior surface. The concrete becomes dislodged from the interior surface, and it may then be manually removed from the mixing drum.

In another aspect of the present invention, a method for removing concrete from a concrete mixing drum is disclosed. A solution including amorphous colloidal silicate is applied to an interior surface of the concrete mixing drum using a pumped delivery and spray apparatus. The solution may comprise a blend of amorphous colloidal silica having a particulate size between nine and three hundred nanometers, water, and at least one abrasive. The solution penetrates concrete adhered to the interior surface. The concrete becomes dislodged from the interior surface, and it may then be manually removed from the mixing drum. The solution forms a coating on the interior surface of the mixing drum to counteract further adhesion between concrete and the mixing drum.

In yet another aspect of the present invention, a method for preventing concrete buildup within a concrete mixing drum is disclosed. A solution including amorphous colloidal silicate is applied to an interior surface of the concrete mixing drum. The solution forms a coating on the interior surface of the mixing drum to counteract adhesion between concrete and the mixing drum.

### DETAILED DESCRIPTION OF THE INVENTION

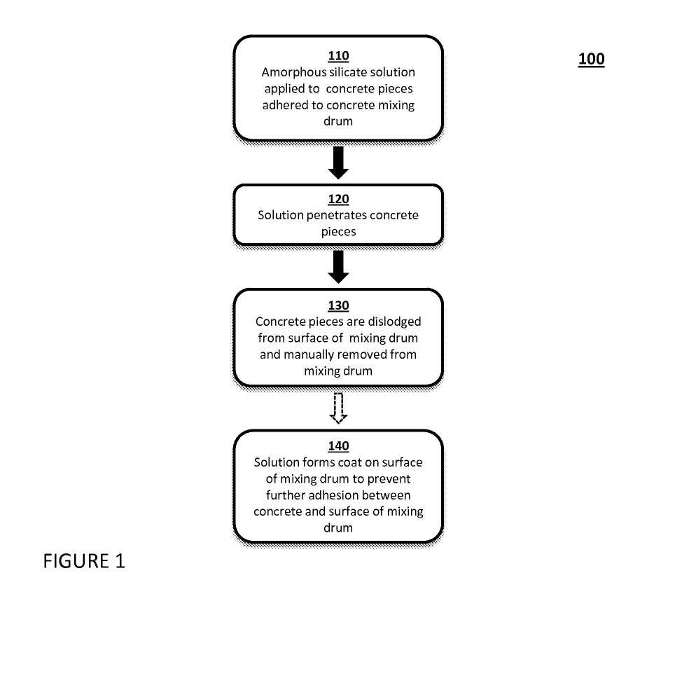

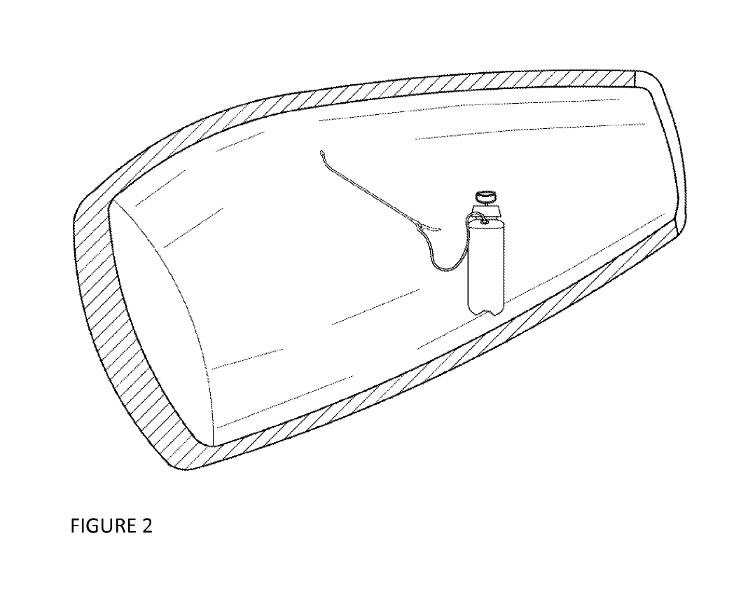

Referring now to FIG. 1, a block diagram of one embodiment of a method for removing concrete from a concrete mixing drum is shown. According to method 100, at step 110, a solution including amorphous silicate is applied to remove uncured, wet, or dried concrete pieces adhered to the surface, either interior or exterior, of a concrete mixing drum or other container for temporarily holding uncured cement. In such embodiments, the solution may be applied directly to the interior surface through the use of a pumped delivery and spray apparatus or other similar mechanism. FIG. 2 shows an exemplary pumped delivery and spray apparatus with a partial concrete mixing drum to illustrate an environment in which the process of applying the solution may take place.

In a preferred embodiment, the composition of the solution is a blend of amorphous colloidal silica with a particle size between about nine to about three hundred nanometers. In other embodiments, other particle sizes outside the aforementioned range may be preferred. In some embodiments, the particle size in a single solution may be substantially the same, or the size of particles in a single solution may vary. The amorphous colloidal silica solution may also include liquids such as water or other components that provide advantageous features and/or facilitate the removal of concrete. For example, the solution may also be used with physical or chemical abrasives or even rock to accelerate the cleaning process.

Referring again to FIG. 1, at step 120, the solution of the invention, upon being sprayed on the interior surface of a concrete mixing drum, penetrates the concrete to counteract the adhesive properties of the cement, which causes the cement to adhere to the surface of the mixing drum.

At step 130, uncured concrete pieces are dislodged from the interior surface of the mixing drum. The uncured concrete pieces may then be manually removed from the mixing drum.

Optionally, at step 140, the solution may further penetrate or otherwise form a coating on the interior surface of the mixing drum, which will subsequently counter or resist adhesion between concrete and the interior surface.

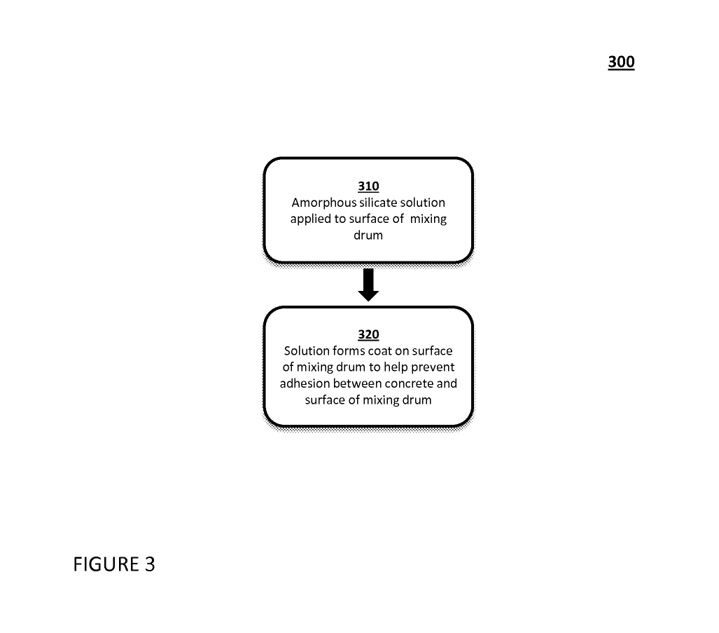

Referring now to FIG. 3, a block diagram of an embodiment of a method for preventing buildup of concrete in a concrete mixing drum is shown. According to method 300, at step 310, a solution including amorphous silicate is applied to the surface, either interior or exterior, of a concrete mixing drum or other container for temporarily holding uncured cement. In such embodiments, the solution may be applied directly to the interior surface through the use of a pumped delivery and spray apparatus or other similar mechanism. At step 320, the solution may penetrate and form a coating on the surface of the mixing drum, which will subsequently counter or resist adhesion between concrete and the interior surface.

It is envisioned that an application of the solution to the concrete mixing drums once per week (such as, for example, when the trucks holding the concrete mixing drums are parked for the weekend) would be sufficient to prevent concrete buildup within the concrete mixing drums.

It will be appreciated by those skilled in the art that while the invention has been described above in connection with particular embodiments and examples, the invention is not necessarily so limited, and that numerous other embodiments, examples, uses, modifications and departures from such embodiments, examples and uses are all intended to be encompassed by the spirit and scope of the invention as described herein and would be understood to one of ordinary skill in the art. In addition, the reference numerals in the claims are merely for convenience and are not to be read in any way as limiting.

What is claimed is:

1. A method for removing concrete from a concrete mixing drum, the method comprising:
applying a solution including amorphous colloidal silicate to an interior surface of the concrete mixing drum;
allowing the solution to penetrate concrete adhered to the interior surface;
dislodging one or more pieces of concrete from the interior surface; and
removing the one or more pieces of concrete from the mixing drum.

2. The method of claim 1, wherein applying the solution is done using a pumped delivery and spray apparatus.

3. The method of claim 1, wherein the solution comprises a blend of amorphous colloidal silica.

4. The method of claim 3, wherein the particle size of the amorphous colloidal silica within the solution is between nine to three hundred nanometers

5. The method of claim 4, wherein the particle size of the amorphous colloidal silica within the solution is substantially the same.

6. The method of claim 4, wherein the particle size of the amorphous colloidal silica within the solution is dissimilar.

7. The method of claim 1, wherein the solution further comprises water.

8. The method of claim 1, wherein the solution further comprises at least one physical abrasive.

9. The method of claim 1, wherein the solution further comprises at least one chemical abrasive.

10. A method for removing concrete from a concrete mixing drum, the method comprising:
applying a solution to an interior surface of the concrete mixing drum using a pumped delivery and spray apparatus, wherein the solution comprises a blend of amorphous colloidal silica having a particulate size between nine and three hundred nanometers, water, and at least one abrasive;
allowing the solution to penetrate concrete adhered to the interior surface;
dislodging one or more pieces of concrete from the interior surface;
removing the one or more pieces of concrete from the mixing drum; and
allowing the solution to form a coating on the interior surface to counteract further adhesion between concrete and the mixing drum.

11. A method for preventing concrete buildup within a concrete mixing drum, the method comprising:
applying a solution including amorphous colloidal silicate to an interior surface of the concrete mixing drum; and
allowing the solution to form a coating on the interior surface to counteract adhesion between concrete and the mixing drum.
